(19) United States
(12) Patent Application Publication
(10) Pub. No.: US 2010/0045245 A1
(43) Pub. Date: Feb. 25, 2010

(54) Control Method for DC/DC Converters and Switching Regulators

(75) Inventor: Stephen W. Hawley, Emerald Hills, CA (US)

Correspondence Address: ADVANCED ANALOGIC TECHNOLOGIES, 3230 Scott Blvd, Santa Clara, CA, 95054, US

(73) Assignee: ADVANCED ANALOGIC TECHNOLOGIES, INC., Santa Clara, CA (US)

(21) Appl. No.: 12/194,291

(22) Filed: Aug. 19, 2008

(51) Int. Cl. G05F 1/00

(52) U.S. Cl. 323/222

(57) ABSTRACT

A circuit for controlling a switching regulator includes a switching control circuit configured to operate one or more switches in a repeating sequence that includes a first state in which an inductor is coupled between an input supply and a load so that an increasing current passes from the input supply through the inductor and a second state in which the inductor is coupled between ground and the load so that a decreasing current passes through the inductor to the load; a circuit configured to cause the switching circuit to select the second state when the magnitude of the increasing current has reached a predetermined level; and a timing circuit configured to cause the switching circuit to select the second state for a predetermined period of time after the initiation of each second first.

### RELATED APPLICATIONS

This application is related to the subject matter of a concurrently filed application entitled “Bi-directional Boost-Buck Voltage Converter.” The disclosure of the concurrently filed application is incorporated in this application by reference.

### BACKGROUND OF THE INVENTION

A switching regulator is a circuit that provides a regulated output under varying load conditions from an unknown and possibly varying input voltage. Many types of switching regulators have been developed, each with its own set of advantages. Some regulate voltage (constant voltage regulators) while others regulate current (constant current regulators). This particular application is directed at a particular class of constant current switching regulator known as inductor-based switching regulators. The two most common types of inductor-based switching regulators are Boost (output voltage greater than input voltage) and Buck (output voltage less than input voltage) switching regulators. Both Boost and Buck switching regulators are very important for battery powered applications such as cell phones.

As shown in FIG. 1A, a traditional implementation for a Buck switching regulator includes a switch S1 connected between an input voltage (VP in this case) and a node LX. A switch S2 is connected between the node LX and ground. An inductor L is connected between LX and the output node (V_{OUT}) of the regulator. A filtering capacitor connects (C₀) V_{OUT} to ground. The node V_{OUT} is also connected to a load represented by the resistor Rload.

A control circuit (described below) turns switches S1 and S2 ON and OFF in a repeating pattern. S1 is driven out of phase with S2. Thus, when S1 is ON, S2 is OFF (and vice versa). This causes the Buck switching regulator to have two distinct operational phases. In the first phase, the switch S1 is ON. During this phase, called the ON-time (T_{ON}), the inductor is connected between the battery and the output node V_{OUT}. This causes current to flow from the battery to the load. In the process energy is stored in the inductor L in the form of a magnetic field. In the second, or OFF-time (T_{OFF}), the switch S1 is opened and the switch S2 is closed. In this phase, the inductor is connected in series between ground and the load. Current supplied by the inductor's collapsing magnetic field flows to the output node V_{OUT} and the load. The duty cycle is defined as:

$$δ = \frac{{T}_{ON}}{{T}_{ON} + {T}_{OFF}}$$

As shown in FIG. 1B, a typical Boost converter includes all of the components just described. A slightly different topology is used in which the switch S2 is placed between the inductor and the output node. The Boost converter uses a similar two phase pattern of switching for its two switches.

To maintain constant output, most switching regulators use some form of feedback control to modulate the duty cycle of their switches. Duty cycle can be modulated using a wide range of techniques including pulse width modulation (PWM) and pulse frequency modulation (PFM). When PWM is used, a fixed switching frequency is used and the duty cycle is altered. When PFM is used, the duration of the pulses remains fixed while their frequency of repetition is altered. In some cases, PWM or PFM based switching regulators are implemented to skip switching cycles during light load conditions.

Duty cycle modulation is generally based on some form of current mode or voltage mode control. Designers constantly seek to optimize these techniques to improve their accuracy and transient response as well as their cost and simplicity of implementation.

### SUMMARY OF THE INVENTION

The present invention provides a control method for constant current switching regulators. The control method may be used with a wide range of inductor-based switching regulator types including buck, boost and buck-boost switching regulators. For a typical boost implementation, an inductor is connected between an input supply (such as a battery) and a node LX. A switch S1 couples the node LX to ground. A second switch S2 further connects the node LX to a load. An optional output capacitor may be placed in parallel with the load between the switch S2 and ground.

A switching logic circuit controls the ON-time and OFF0-time. The switching logic circuit generates the signals to turn switches S1 and S2 ON and OFF and ensures that each switch is turned OFF before the other switch is turned ON (i.e., ensures that a make-before-break period is implemented).

The switching logic circuit is controlled by the output (OS) of a one-shot circuit. The one-shot is controlled, in turn by the output of a comparator. The inputs to the comparator are a reference voltage (V_{REF}) (generated by any convenient method) and the output of a current sense circuit. The current sense circuit measures the current passing through the inductor and converts the magnitude of that current into a corresponding voltage. Numerous methods can be used to measure this current including placing a sense resistor in series with the inductor and measuring the voltage drop over an existing element such as switch S1 Operation begins when the logic circuit turns the switch S1 ON and the switch S2 OFF. This connects the inductor is connected between the input supply and ground, causing current to flow through the inductor to ground. This is referred to as the charging phase. The nature of the inductor means that the charging current increases or ramps linearly over time. The output of the current sense circuit increases in proportion to the ramping current.

Once the output of the current sense circuit has reached a predetermined level (i.e., when the inductor current has reached a predetermined level) it exceeds the reference voltage V_{REF} causing the comparator to trigger. This, in turn causes the one-shot to trigger to trigger forcing its output into a logically high state. The logic circuit responds by turning the switch S1 OFF and the switch S2 ON, connecting the inductor between the input supply ground and load. Current, at a boosted voltage flows from the inductor into the load as the magnetic field of the inductor collapses. This is referred to as the OFF-time. The OFF-time is maintained until the one-shot times out after a predetermined period and resets at which time the switching logic circuit once again initiates the ON-time turning the switch S1 ON and the switch S2 OFF.

The series of charging and discharge phases repeats under control of the one-shot, comparator and current sense circuit. The output current (the current to the load) is maintained at a constant level by the fixed OFF time provided by the one-shot and the variable ON time provided by the comparator and current sense circuit. In this way, the present invention provides a constant input current control method for the boost regulator just described. With suitable modifications, the same method may be adapted to buck regulators providing constant output current as well as more arcane regulators such as buck-boost and SEPIC converters.

### BRIEF DESCRIPTION OF THE DRAWINGS

FIG. 1A is a schematic of a prior art synchronous buck converter.

FIG. 1B is a schematic of a prior art synchronous boost converter.

FIG. 2 is a schematic of a synchronous buck converter that includes the control method of the present invention.

FIG. 3 is a graph showing inductor current as a function of time for the converter of FIG. 2.

FIG. 4 is a schematic of a synchronous boost converter that includes the control method of the present invention.

FIG. 5 is a graph showing inductor current as a function of time for the converter of FIG. 4.

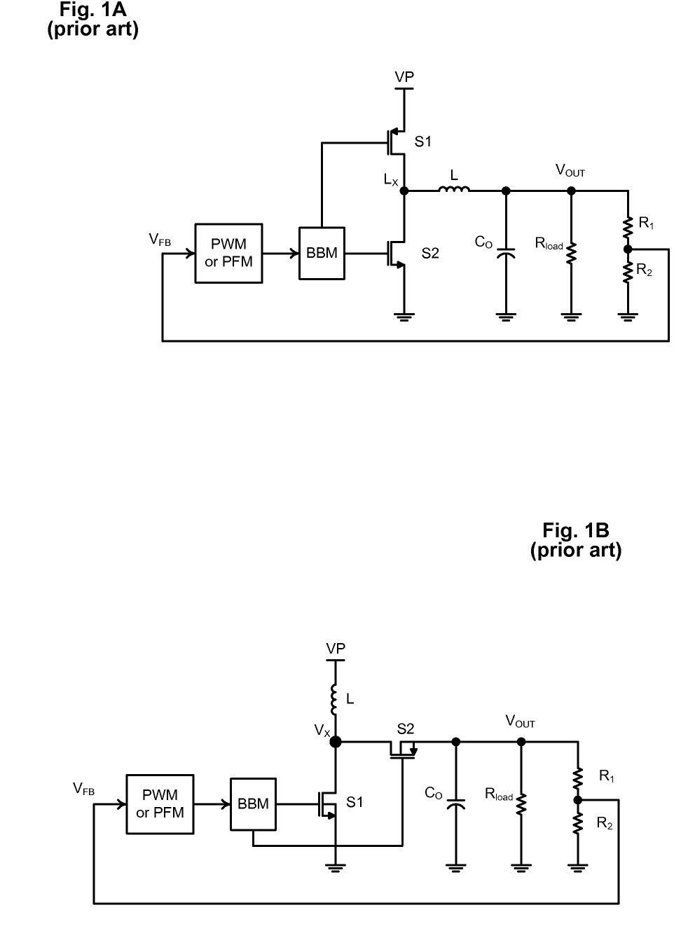

### DETAILED DESCRIPTION OF THE PREFERRED EMBODIMENTS

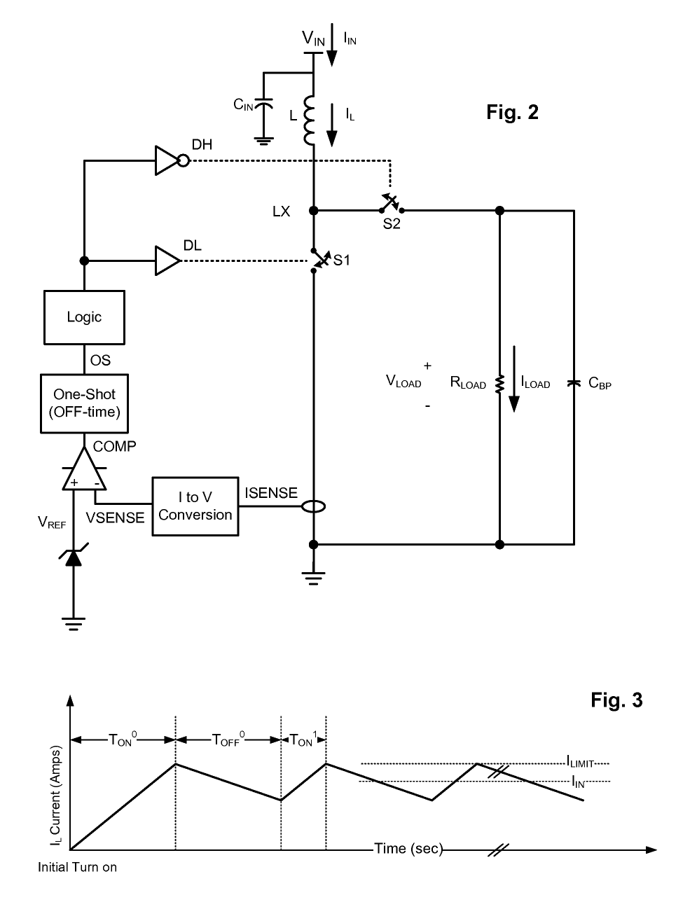

The present invention provides a control method for constant current switching regulators. As shown in FIG. 2, a representative switching regulator 200 implemented to use the control method includes an inductor coupled between an input supply (such as a battery) and a node LX. A switch S1 couples the node LX to ground. A second switch S2 further couples the node LX to a load (represented here by a resistor). An optional output capacitor may be placed in parallel with the load (resistor) between the switch S2 and ground.

A switching logic circuit controls the first and second switches through respective buffers. The buffers are labeled DL for the buffer associated with switch S1 and DH for the buffer associated with switch S2. The switching logic circuit generates the signals to turn switches S1 and S2 ON and OFF and ensures that each switch is turned OFF before the other switch is turned ON (i.e., ensures that a make-before-break period is implemented).

The switching logic circuit is controlled by the output (OS) of a one-shot circuit. The one-shot is controlled, in turn by the output of a comparator. The inputs to the comparator are a reference voltage (V_{REF}) (generated by any convenient method) and the output of a current sense circuit. The current sense circuit measures the current passing through the inductor and converts the magnitude of that current into a corresponding voltage. Numerous methods can be used to measure this current including placing a sense resistor in series with the inductor and measuring the voltage drop over an existing element such as switch S1

Whenever the COMP signal transitions to a logically low value, the switching circuit turns the switch S1 ON and the switch S2 OFF. In this configuration, the inductor is connected between the input supply and ground. Current travels through the inductor to ground storing energy in the inductor in the form of a magnetic field. This is referred to as the ON-time. The presence of the inductor means that this current increases, or ramps linearly as a function of time. Once the current has reached a predetermined level, the current-sense voltage produced by the current sense circuit exceeds the reference voltage V_{REF}. This causes the comparator to trigger which, in turn causes the one-shot to trigger.

When the one-shot triggers, its output goes to a logically high level for a fixed period of time. This signal causes the switching control circuit to turn the switch S1 OFF and the switch S2 ON. In this configuration, the inductor is coupled in series with the load between the input supply ground and ground causing current to flow from the inductor into the load as the magnetic field of the inductor collapses. This is referred to as the constant OFF-time (T_{OFF}). The discharge phase is maintained until the one-shot times out and resets at which time the switching logic circuit once again turns the switch S1 ON and the switch S2 OFF.

As shown in FIG. 3, operation of switching boost voltage regulator begins with an initial charging phase (T_{ON}⁰). During the ON-time\, the inductor current increases at a rate proportional to the input voltage and inductance. Once the current has reaches a predetermined limit (I_{LIMIT}) then the voltage V_{SENSE} becomes equal to the reference voltage V_{REF}. This causes the comparator to trigger which, in turn causes the one-shot to trigger. As discussed above, this ends the charging phase as the switching control circuit turns the switch S1 OFF and the switch S2 ON.

In the following OFF-time (T_{OFF}⁰) power is delivered to the load as the inductor discharges and the inductor current decreases. Unlike the charging phase, the discharge phase has a fixed duration controlled by the configuration of the one-shot. Thus, the discharge phase (T_{OFF}⁰) continues until the one-shot times out and the next charging phase (T_{ON}¹) begins. The cycles repeat; and average current from the input (I_{IN}) is regulated as determined by the I_{LIMIT} threshold, OFF-time (T_{OFF}) and L as follows:

I_{IN(AVG)}=I_{LIMIT}−V_{LOAD}×T_{OFF}/(L×2)

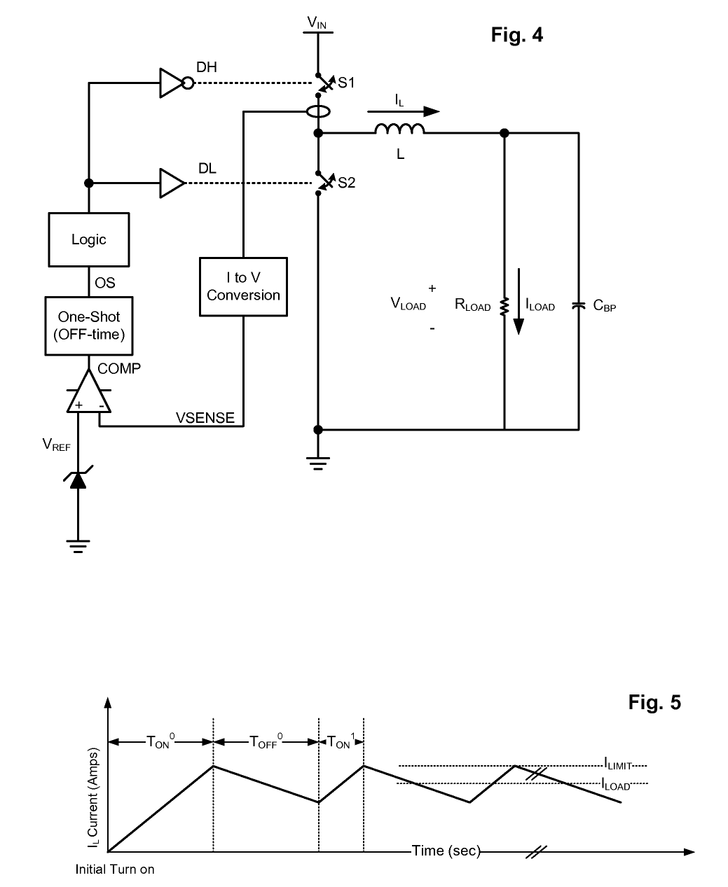

Based on the topology of the switches S1, S2 and the inductor, it is easy to recognize switching regulator 200 as a boost regulator. FIG. 4 continues this description by showing application of the control method to a buck switching regulator 400. As shown in FIG. 4, buck switching regulator 400 includes a switch coupled between an input supply (such as a battery) and a node LX. A second switch S2 couples the node LX to ground. An inductor further couples the node LX to a load (represented here by a resistor). An optional output capacitor (C_{BP}) may be placed parallel to the load between the inductor and ground to reduce ripple current flowing in the load.

A switching logic circuit controls the first and second switches through respective buffers. The buffers are labeled DH for buffer associated with switch S1 and DL for the buffer associated with switch S2. The switching logic circuit generates the signals to turn switches S1 and S2 ON and OFF and ensures that each switch is turned OFF before the other switch is turned ON (i.e., ensures that a make-before-break period is implemented).

The switching logic circuit is controlled by the output (OS) of a one-shot circuit. The one-shot is controlled, in turn by the output of a comparator. The inputs to the comparator are a reference voltage (generated by any convenient method) and the output of a current sense circuit. The current sense circuit measures the current passing through the inductor during the charging phase and converts the magnitude of that current into a corresponding voltage. Numerous methods can be used to measure this current including placing a sense resistor in series with the inductor and measuring the voltage drop over an existing element such as switch S1

Whenever the COMP signal transitions to a logically low value, the switching circuit turns the switch S1 ON and the switch S2 OFF. In this configuration, the inductor is connected in series with the load between the input supply and ground. Current travels through the inductor to the load, powering the load and storing energy in the inductor in the form of a magnetic field. This is referred to as the ON-time. The presence of the inductor means that this current increases, or ramps linearly as a function of time. Once the current has reached a predetermined level, the current-sense voltage produced by the current sense circuit exceeds the reference voltage V_{REF}. This causes the comparator to go low which, in turn causes the one-shot to trigger.

When the one-shot triggers, it causes the switching control logic circuit to turn the switch S1 OFF and the switch S2 ON. In this configuration, the inductor is coupled between ground and the load causing current to flow from the inductor into the load as the magnetic field of the inductor collapses. This is referred to as the OFF-time. This discharge phase is maintained until the one-shot times out and resets at which time the switching logic circuit once again turns the switch S1 ON and the switch S2 OFF.

As shown in FIG. 5, operation of switching buck voltage regulator begins with an initial charging phase (T_{ON}⁰). During this initial charging phase, the inductor current increases at a rate proportional to the input voltage and inductance. Once the current has reaches a predetermined limit (I_{LIMIT}) then the voltage V_{SENSE} becomes equal to the reference voltage V_{REF}. This causes the comparator to trigger which, in turn causes the one-shot to trigger. As discussed above, this ends the charging phase as the switching control circuit turns the switch S1 OFF and the switch S2 ON for a fixed period of time.

In the following discharge phase (T_{OFF}⁰) power is delivered to the load as the inductor discharges and the inductor current decreases. Unlike the charging phase, the discharge phase has a fixed duration controlled by the configuration of the one-shot. Thus, the discharge phase (T_{OFF}⁰) continues until the one-shot times out and the next charging phase (T_{ON}¹) begins. The cycles repeat; and average current to the load (I_{LOAD}) is regulated as determined by the I_{LIMIT} threshold, OFF-time (T_{OFF}) and L as follows:

I_{LOAD(average)}=I_{LIMIT}−V_{LOAD}×T_{OFF}/(L×2)

What is claimed is:

1. A method for controlling a switching regulator, where the switching regulator includes an inductor operating under the control of one or more switches, the method comprising the steps of:
configuring the one or more switches into a first state to couple the inductor between an input supply and ground so that an increasing current passes from the input supply through the inductor;
configuring the one or more switches into a second state when the magnitude of the increasing current has reached a predetermined level where the second state couples the inductor between the input supply and a load so that a decreasing current passes from the input supply through the inductor; and
configuring the one or more switches into the first state to limit the duration of the second state to a predetermined period of time.

2. A method as recited in claim 1 that further comprises the steps of:
generating a voltage that is proportional to the increasing current;
comparing the generated voltage to the a reference voltage; and
triggering a one-shot (constant discharge-time) timer when the generated voltage exceeds the reference voltage.

3. A method as recited in claim 1 where the one or more switches includes a first switch connected between the inductor and ground and a second switch connected between the inductor and the load.

4. A method as recited in claim 3 where the switching regulator is a boost, or voltage increasing regulator.

5. A circuit for controlling a switching regulator, where the switching regulator includes an inductor and one or more switches, the circuit comprising:
a switching control circuit configured to operate the one or more switches in a repeating sequence that includes a first state in which the inductor is coupled between an input supply and ground so that an increasing current passes from the input supply through the inductor and a second state in which the inductor is coupled between the input supply and a load so that a decreasing current passes from the input supply through the inductor;
a circuit configured to cause the switching circuit to select the second state when the magnitude of the increasing current has reached a predetermined level; and
a timing circuit configured to cause the switching circuit to select the first state a predetermined period of time after the initiation of each second state.

6. A circuit as recited in claim 5 that further comprises the steps of:
a one-shot timer;
means for generating a current monitoring voltage that is proportional to the increasing current;
a comparator that triggers the one-shot timer when the current monitoring voltage exceeds the reference voltage.

7. A circuit as recited in claim 5 where the one or more switches includes a first switch connected between the inductor and ground and a second switch connected between the inductor and the load.

8. A circuit as recited in claim 7 where the switching regulator is a boost, or voltage increasing regulator.

9. A method for controlling a switching regulator, where the switching regulator includes an inductor operating under the control of one or more switches, the method comprising the steps of:
configuring the one or more switches into a first state to couple the inductor between an input supply and a load so that an increasing current passes from the input supply through the inductor;
configuring the one or more switches into a second state when the magnitude of the increasing current has reached a predetermined level where the second state couples the inductor between the ground and the load so that a decreasing current passes through the inductor to the load; and
configuring the one or more switches into the first state to limit the duration of the second state to a predetermined period of time.

10. A method as recited in claim 9 that further comprises the steps of:
generating a voltage that is proportional to the increasing current;
comparing the generated voltage to the a reference voltage; and
triggering a one-shot timer when the generated voltage exceeds the reference voltage.

11. A method as recited in claim 10 where the one or more switches includes a first switch connected between the inductor and ground and a second switch connected between the inductor and the input supply.

12. A method as recited in claim 12 where the switching regulator is a buck, or voltage decreasing regulator.

13. A circuit for controlling a switching regulator, where the switching regulator includes an inductor and one or more switches, the circuit comprising:
a switching control circuit configured to operate the one or more switches in a repeating sequence that includes a first state in which the inductor is coupled between an input supply and a load so that an increasing current passes from the input supply through the inductor and a second state in which the inductor is coupled between ground and the load so that a decreasing current passes through the inductor to the load;
a circuit configured to cause the switching circuit to select the second state when the magnitude of the increasing current has reached a predetermined level; and
a timing circuit configured to cause the switching circuit to select the first state a predetermined period of time after the initiation of each second state.

14. A circuit as recited in claim 13 that further comprises the steps of:
a one-shot timer;
means for generating a current monitoring voltage that is proportional to the increasing current;
a comparator that triggers the one-shot timer when the current monitoring voltage exceeds the reference voltage.

15. A circuit as recited in claim 13 where the one or more switches includes a first switch connected between the inductor and ground and a second switch connected between the inductor and the input supply.

16. A circuit as recited in claim 13 where the switching regulator is a buck, or voltage decreasing regulator.
